(19) United States
(12) Patent Application Publication
(10) Pub. No.: US 2006/0057441 A1
(43) Pub. Date: Mar. 16, 2006

(54) Using a fuel cell as energy storage for inverter and converter systems

(76) Inventor: Robert Henry Wills, Temple, NH (US)

Correspondence Address: TROP PRUNER & HU, PC, 8554 KATY FREEWAY, SUITE 100, HOUSTON, TX, 77024, US

(21) Appl. No.: 11/220,505

(22) Filed: Sep. 7, 2005

Related U.S. Application Data
(60) Provisional application No. 60/609,155, filed on Sep. 10, 2004.

(51) Int. Cl. H01M 8/00

(52) U.S. Cl. 429/13

(57) ABSTRACT

A technique that is usable with a fuel cell stack includes using a capacitance of the fuel cell stack as a main component of an input capacitance of an inverter. The technique may include, in some embodiments of the invention, using the capacitance of the fuel cell stack as a capacitance for a converter. For example, in these embodiments of the invention, the capacitance may be an input capacitance or an output capacitance of the converter.

This application claims the benefit under 35 U.S.C. § 119(e) to U.S. Provisional Patent Application Ser. No. 60/609,155 entitled, “USING A FUEL CELL AS ENERGY STORAGE FOR INVERTER AND CONVERTER SYSTEMS,” filed on Sep. 10, 2004.

### BACKGROUND

The invention generally relates to using a fuel cell as energy storage for inverter and converter systems.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack may be part of a fuel cell system that provides power to an AC load. For purposes of converting the DC power that is provided by the fuel cell stack into AC power for the load, the fuel cell system typically includes an inverter. Although the inverter ideally has a DC input voltage, the inverter, in its normal operation, undesirably produces an input ripple current which causes a ripple voltage component to appear on its input terminals. To limit the magnitude of the input ripple voltage, a significant amount of energy storage typically is included in the inverter. Energy storage is also included in the inverter to supply power for transient loads. However, providing this energy storage typically is a challenge, in that an energy storage device (a capacitor, for example) that is of the appropriate size to provide the needed energy storage typically is relatively expensive (as compared to other components of the fuel cell system) and may contribute significantly to the overall cost of fuel cell system.

The fuel cell stack may be part of a fuel cell system that provides power to a DC load. For purposes of converting the DC power that is provided by the fuel cell stack into DC power for the load at an appropriate, regulated voltage, the fuel cell system typically includes an converter. Energy storage is included in a converter to filter high frequency switching currents and to provide energy for transient loads. The energy storage needed in a converter typically is relatively expensive (as compared to other components of the fuel cell system) and may contribute significantly to the overall cost of fuel cell system.

Thus, there is a continuing need for better ways to reduce the cost of energy storage in a fuel cell system.

### SUMMARY

In an embodiment of the invention, a technique that is usable with a fuel cell stack includes using a capacitance of the fuel cell stack as a main component of the energy storage of an inverter.

In another embodiment of the invention, a technique that is usable with a fuel cell stack includes using a capacitance of the fuel cell stack as a main component of the energy storage of a converter.

Advantages and other features of the invention will become apparent from the following drawing, description and claims.

### BRIEF DESCRIPTION OF THE DRAWING

FIG. 1 is a flow diagram depicting a technique to reduce energy storage costs of a fuel cell system according to an embodiment of the invention.

FIG. 2 illustrates an output voltage and an output current of an inverter.

FIG. 3 depicts a power output of an inverter.

FIG. 4 depicts an input current of an inverter.

FIGS. 5, 8, 9, 10, 11 and 14 depict fuel cell systems according to different embodiments of the invention.

FIGS. 6, 7 and 12 depict different power subsystems of the fuel cell system according to different embodiments of the invention.

FIG. 13 is a flow diagram depicting a technique to reduce energy storage costs of the fuel cell system according to an embodiment of the invention.

### DETAILED DESCRIPTION

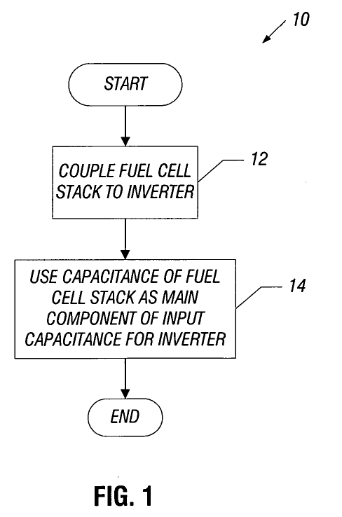

Referring to FIG. 1, an embodiment 10 of a technique in accordance with the invention reduces the energy storage costs of a fuel cell system. More specifically, the technique 10 includes coupling (block 12) a fuel cell stack to an inverter and using (block 14) the capacitance of the fuel cell stack as a main component of the energy storage for the inverter. The technique 10 takes advantage of the recognition that at the operating frequency (60 Hertz (Hz)) of the inverter which causes a 120 Hz input current, the fuel cell stack exhibits a large capacitance, which is attributable to the double layer capacitances of the fuel cells that form the stack.

Thus, by using this large capacitance of the fuel cell stack as the main component of the input capacitance for the inverter, the energy storage costs of fuel cell systems are reduced. Not only does the use of the fuel cell stack in this manner reduce the energy storage costs, typically, the capacitor that is otherwise used as the input capacitance for the inverter may be one of the least reliable components in the inverter. Therefore, among the possible advantages of the technique 10, costs are reduced and potentially non-reliable components are eliminated from the fuel cell system design. Furthermore, the size of the inverter is reduced, and high efficiency (greater than 95%, for example) operation is possible.

In the context of this application, the phrase “main component” means a component that is at least as large and, in most cases, larger than any other related component. For example, when the capacitance of the fuel cell stack is a “main component” of the input capacitance of the inverter, this means that the capacitance is at least one half of the total input capacitance that exists at the input terminals of the inverter. In some embodiments of the invention, the capacitance exhibited by the fuel cell stack may be approximately 90 percent or greater of the total capacitance that appears at the input terminals of the inverter.

The need for the input capacitance results from the instantaneous power requirements of the inverter. More specifically, the output voltage of the inverter may be described as follows:
V=Vo\sqrt{2} sin(wt), Equation 3
where “Vo” represents the RMS component of the output voltage, and “w” represents the AC radian frequency (2 pi f, where f is typically 60 Hz). The output current of the inverter may be described as follows:
I=Io\sqrt{2} sin(wt), Equation 4
wherein “Io” represents the RMS value of the output current.

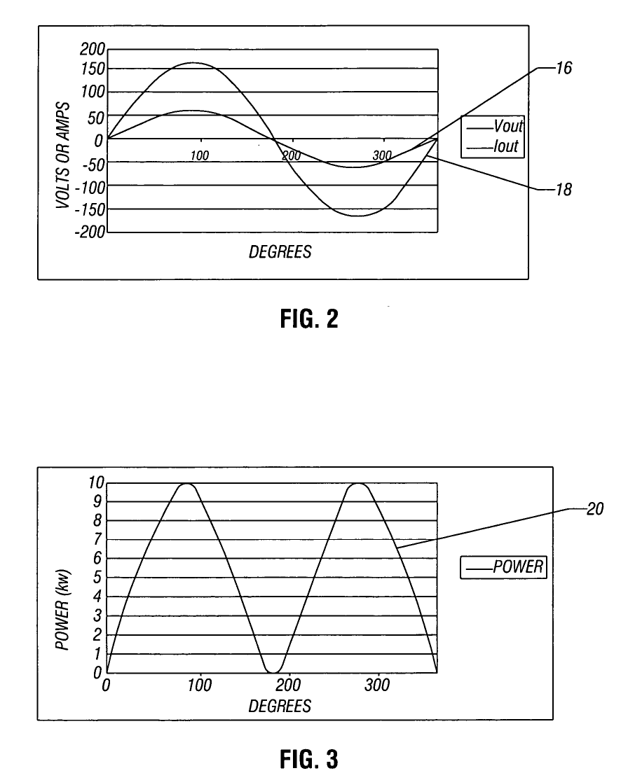

The output voltage and output current are illustrated in FIG. 2 by the waveforms 16 and 18, respectively. As can be seen, in this example, the output current waveform 16 has an amplitude of 60 A peak (42 A rms), and the output voltage waveform 18 has an output amplitude of approximately 170V peak (120 V rms).

The output power of the inverter, which is the product of the output voltage and output current described in Equations 3 and 4 above, may be described as follows:
P=VoIo(1+sin(2 wt)), Equation 5

Graphically, the output power of the inverter is represented by a waveform 20 in FIG. 3. In this example, it has an average value of 5 kW and a peak value of 10 kW. Comparing FIGS. 2 and 3, it can be seen that the output power has a frequency that is twice the frequency of either the output voltage or output current of the inverter.

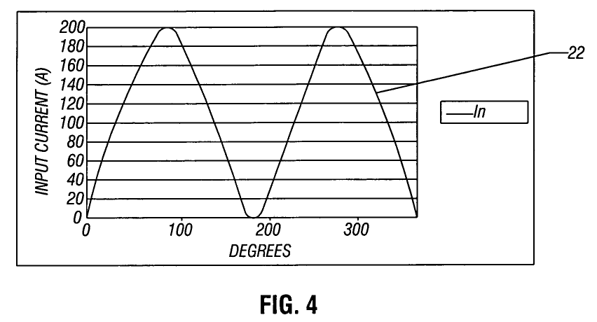

If the inverter has an ideal constant input voltage, the input current of the inverter, if unfiltered, is a 120 Hz sinusoid, as described in the following equation:

$${I}_{in} = \frac{Vo Io}{Vi} ( 1 + sin ( 2 wt ) ) , \qquad Equation 6$$

wherein “Vi” represents the constant input voltage of the inverter (50V for this example). FIG. 4 depicts a waveform 22 of the input current of the inverter. As shown, the input current waveform 22 has an amplitude of approximately 200A peak to peak (for this example) and has a frequency that is twice the frequency of the inverter's output voltage and output current. The average input current is 100 A and the average input power is 50V×100 A=5 kW. Sinusoidal ripple current will be generated by any single-phase inverter, or any poly-phase inverter with an unbalanced load, so this technique is applicable to both single and poly-phase inverters.

The input voltage to the inverter is not ideally constant, but rather, the input voltage may be represented by a constant DC voltage and a superimposed ripple voltage component. To ensure proper operation of the fuel cell system, a limit is placed on the magnitude of the peak-to-peak voltage of this ripple component, and the limit is established by the input capacitance of the inverter. More specifically, the relationship between the input capacitance and the limit is set forth below:

$$C = \frac{ⅆ E}{V ⅆ V} , \qquad Equation 7$$

where “dE” represents the energy contained in one input cycle of the output power, “V” represents the amplitude of the input voltage to the inverter; and “dV” represents the desired peak-to-peak voltage of the ripple component.

As a more specific example, the following parameters may be assumed: the input power to the inverter is 5 kilowatts (kW); the energy contained in one 5 kW input cycle is 41.6 Joules; the input voltage to the converter has an amplitude of 50V; and the desired peak-to-peak voltage of the ripple component is 10V. Based on these parameters, the input capacitance needed to limit the peak-to-peak ripple voltage component to 10V is 80,000 μF. Other values are possible in other embodiments of the invention.

The example above demonstrates the significant cost that is attributable to the input capacitance of a typical inverter. More specifically, the cost of an 80,000 μF capacitor for the specifications described above typically is approximately $100. Therefore, significantly reducing or eliminating this discrete component of the fuel cell system significantly reduces the overall cost of the system.

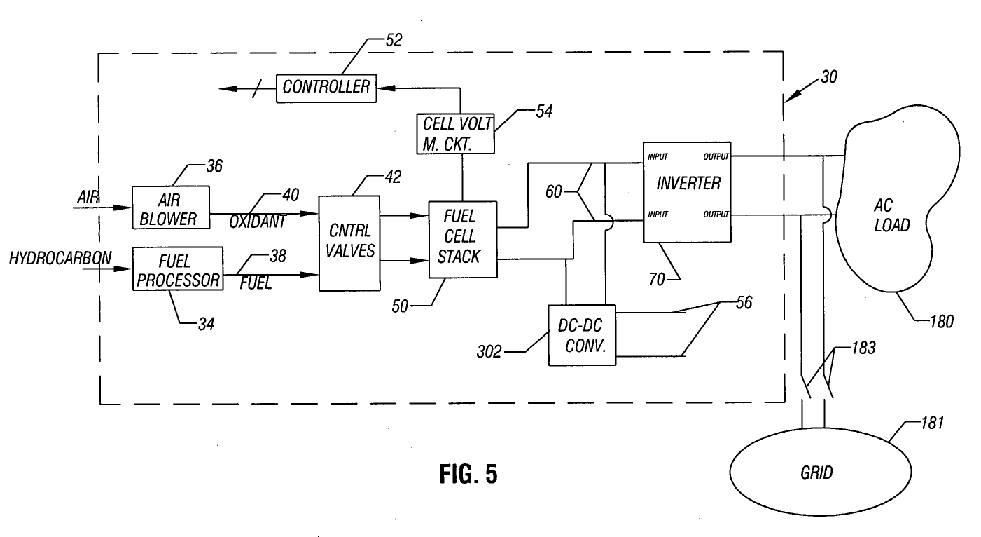

Referring to FIG. 5, as a more specific example, in some embodiments of the invention, the technique 10 may be used in connection with a fuel cell system 30. The fuel cell system 30 includes a fuel cell stack 50 (a PEM-type fuel cell stack, for example) that is capable of producing power that is used to power an AC power consuming, external load 180. The power that is produced by the fuel cell stack 50 is in response to fuel and oxidant flows that are provided by a fuel processor 34 and an air blower 36, respectively. More specifically, the fuel cell system 30 controls the fuel production of the fuel processor 34 (i.e., controls the rate at which the fuel processor 34 provides reformate) to control the fuel flow that is available for electrochemical reactions inside the fuel cell stack 50. Control valves 42 of the fuel cell system 30 generally route most of the fuel flow to the stack 50, with the remainder of the fuel flow being diverted to a flare, or oxidizer (not depicted in FIG. 5).

The fuel cell stack 50 includes output terminals that provide a DC voltage to a fuel cell bus 60. This fuel cell bus 60, in turn, connects the terminals of the fuel cell stack 50 to input terminals of an inverter 70. The inverter 70, in response to the DC input power that is provided from the fuel cell stack 50, produces AC power for the load 180.

In some embodiments of the invention, the fuel cell system 30 may provide power to a power grid 181 when switches 183 (provided by the contacts of a relay, for example) are closed to connect the output terminals of the inverter 70 to the power grid 181. Additionally, in some embodiments of the invention, the fuel cell system 30 may close the switches 183 for purposes of receiving power from the grid 181. More particularly, the fuel cell system 30 may close the switches 183 to receive power from the grid 181 during the startup of the system 30, in some embodiments of the invention.

Among its other features, the fuel cell system 30 may include a DC-DC converter 55 that is connected to the fuel cell bus 60 for purposes of generating auxiliary voltages (that appear on output terminals 56 of the converter 55) to power the various power consuming components of the system 30. These power consuming components may include, for example, a cell voltage monitoring circuit 54 that, in some embodiments of the invention, scans the cell voltages of the fuel cell stack 50 for purposes of monitoring the performance and condition of the fuel cells of the fuel cell stack 50. The cell voltage monitoring circuit 54 may communicate the scanned cell voltages to a controller 52, another power consuming component of the fuel cell system 30. The controller 52, controls the fuel processor 34 and other components of the fuel cell stack 30 (via output control lines 53) based on the monitored voltages as well as monitored currents and other monitored parameters of the fuel cell system 30.

The fuel cell system 30 may have various other components and subsystems that are not depicted in FIG. 5. For example, the fuel cell system 30, in some embodiments of the invention, may have a coolant subsystem for purposes of regulating a temperature of the fuel cell stack, may include various switches and/or relays for purposes of emergency disconnection purposes, may include an exhaust recirculation subsystem, etc.

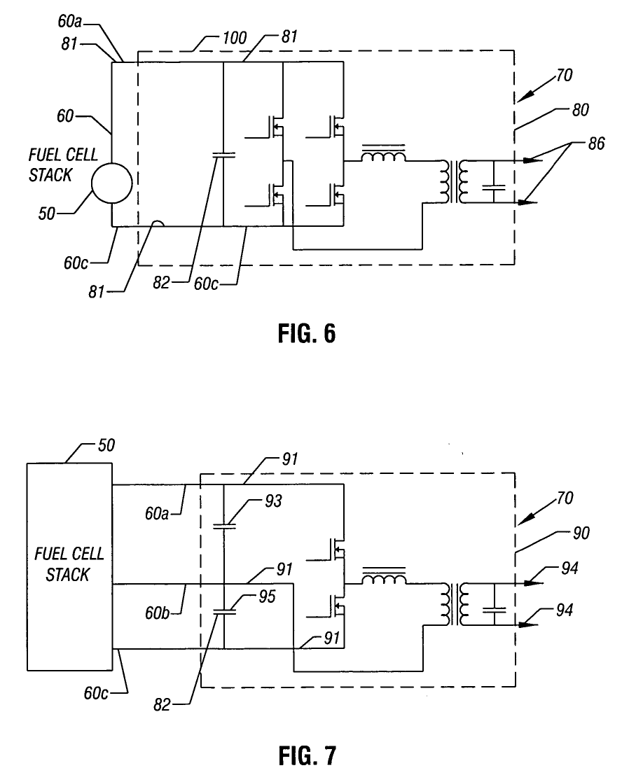

As depicted in FIG. 5, the output terminals of the fuel cell stack 50 are connected to the input terminals of the inverter 70. This connection, as described below, allows the capacitance of the fuel cell stack 50 to serve as the main component of the input capacitance of the inverter 70. As a more specific example, in some embodiments of the invention, the inverter 70 may be a full bridge inverter 80 that is depicted in FIG. 6.

Referring to FIG. 6, the full bridge inverter 80 has two input terminals 81 that are connected to two lines 60a and 60c of the fuel cell bus 60; and the lines 60a and 60c are coupled across the main terminals of the fuel cell stack 50. In a conventional system, a capacitor that has a capacitance sufficient to limit the peak-to-peak ripple input voltage component to a desired level is connected between the input terminals 81 of the inverter 80. However, unlike these conventional systems, the inverter 80 uses the fuel cell stack 50 to partly or fully replace this capacitor.

FIG. 6 depicts a capacitor 82 that is connected between the input terminals 81. This capacitor 82, however, is significantly smaller than the capacitance that is provided by the fuel cell stack 50; and the capacitor 82 that carries the inverter switching frequency current. The cost of the capacitor 82 is significantly smaller than the cost of the capacitor that would otherwise be required if not for the capacitance that is provided by the fuel cell stack 50. As also depicted in FIG. 6, the inverter 80 includes output terminals 86 that provide an AC voltage for the load 180.

Other inverter topologies may be used in other embodiments of the invention. For example, in some embodiments of the invention, the inverter 70 (FIG. 5) may use a half bridge inverter 90 that is depicted in FIG. 7. Referring to FIG. 7, the half bridge inverter 90 may be advantageous due to the fewer number of switching components (two for the inverter 90, as compared to four for the inverter 80). As depicted in FIG. 7, the half bridge inverter 90 includes three input terminals that are connected to three lines 60a, 60b and 60c of the fuel cell bus 60. The line 60a is connected to the highest DC potential from the fuel cell stack 50; the line 60b is connected to the midpoint potential of the fuel cell stack 50; and the line 60c is connected to the lowest potential from the fuel cell stack 50. Thus, due to the connection illustrated in FIG. 7, one half of the fuel cell stack 50 provides a capacitance between the lines 60a and 60b; and the other half of the fuel cell stack 50 provides a capacitance between the lines 60b and 60c.

As depicted in FIG. 7, the half bridge inverter 90 includes a capacitor 93 that is connected between the lines 60a and 60b and a capacitor 95 that is connected between the lines 60b and 60c. These capacitors 93 and 95 are high frequency capacitors that have relatively small capacitances, as compared to the capacitances of the fuel cell stack 50; and thus, these capacitors 93 and 95 are relatively low cost components, as compared to their costs if not for the capacitance of the fuel cell stack 50.

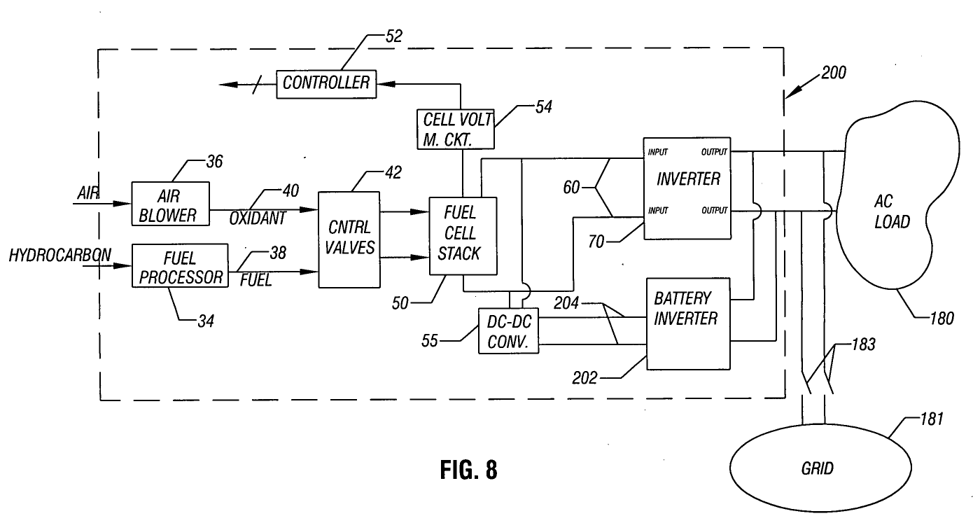

The fuel cell system 30 (FIG. 5) illustrates one out of numerous possible embodiments of the invention. For example, the fuel cell system may contain additional and/or different circuitry for purposes of powering the components of the fuel cell system. In this regard, referring to FIG. 8, in another embodiment of the invention, a fuel cell system 200 has a similar design to the fuel cell system 30, with the following differences. In particular, the fuel cell system 200 includes an inverter 202 (in addition to the inverter 70) that has a battery at its input terminals 204. The terminals 204, in turn, are connected to the fuel cell bus 60, so that power may be provided to the fuel cell stack 50 during startup of the fuel cell system 30. The inverter 202 may be, for example, a non-isolated full or half bridge inverter, depending on the particular embodiment of the invention.

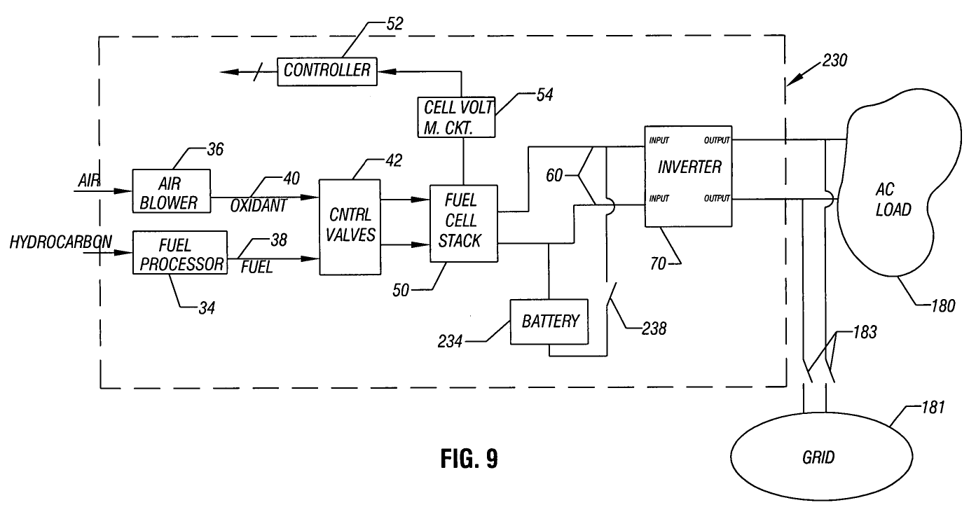

As an example of another variation, FIG. 9 depicts a fuel cell system 230 that has a similar design to the fuel cell system 30 with the following differences. In particular, the fuel cell system 230 includes a battery 234 that is selectively connected, via switch 238, to the fuel cell bus 60. Due to this arrangement, the battery 234 may be connected (by its operation via the controller 52) to connect the battery 234 to the fuel cell bus 60 during startup of the fuel cell system 30.

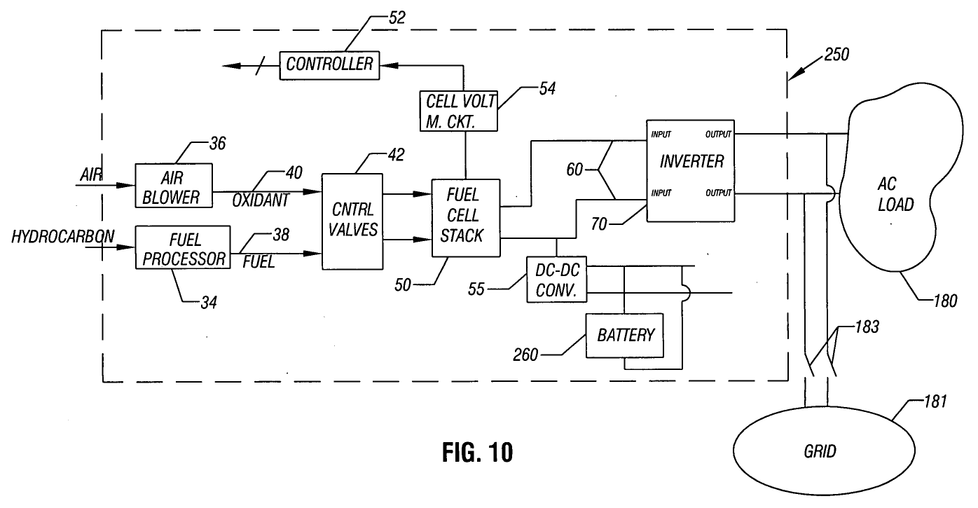

In another arrangement, a fuel cell system 250, that is depicted in FIG. 10, may be used in place of the fuel cell system 30. The fuel cell system 250 has a similar design to the fuel cell system 30, with the following differences. In particular, the fuel cell system 250 includes a battery 260 that is connected to the output terminals 56 of the DC-DC converter 55. Due to this arrangement, the battery 260 provides power for the components of the fuel cell system 250 during startup.

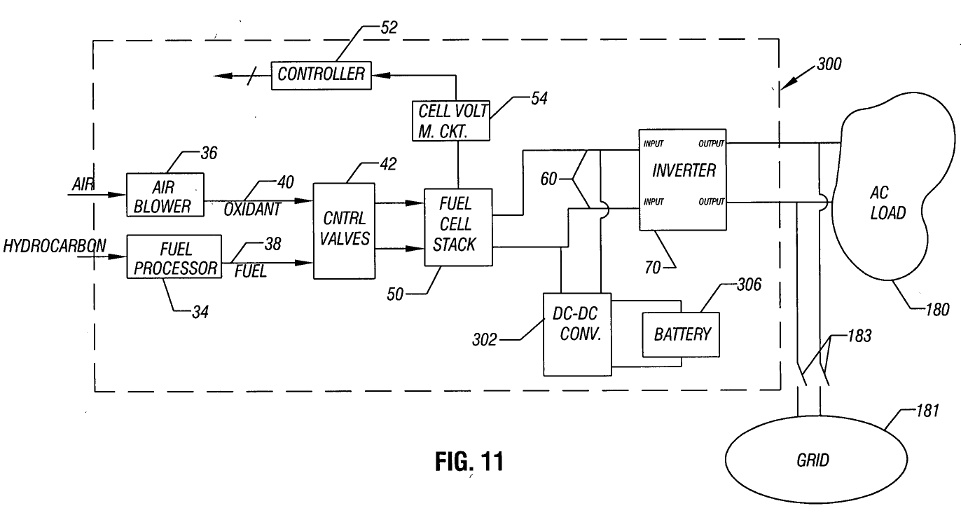

Referring to FIG. 11, in yet another variation, a fuel cell system 300 may be used in place of the fuel cell system 30. More specifically, the fuel cell system 300 has a similar design to the fuel cell system 30, with the following differences. The fuel cell system 300 includes a DC-DC converter 302 that has its input terminals connected to the fuel cell bus 60. The DC-DC converter 302 also has output terminals that are coupled to a battery 306.

In some embodiments of the invention, the DC-DC converter 302 is a bi-directional converter to interface the battery 306 to the fuel cell bus 60. In one mode of operation, energy flows through the converter 302 from the fuel cell bus 60 to the battery 306. In another mode of operation, energy flows through the converter 302 from the battery 306 to the fuel cell bus 60. The battery 306 may be a relatively high voltage battery, which may be advantageous if high surge powers are required, as battery and converter currents are kept relatively low due to the high terminal voltage of the battery 306.

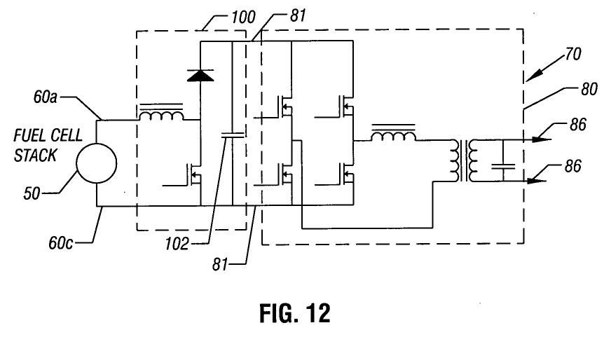

Other variations that fall with the scope of the appended claims are possible. For example, FIG. 12 depicts an arrangement in which the fuel cell stack 50 has an intervening component, a Boost converter 100, that is coupled between the fuel cell stack 50 and the full bridge inverter 80. In other embodiments of the invention, the full bridge inverter 80 may be replaced by a half bridge inverter. The Boost converter 100, as its name implies, provides a step-up, or boost, in the fuel cell stack's terminal voltage such that a transformer is not required between the fuel cell stack 50 and the inverter 80. Thus, a potential advantage of this arrangement is that a relatively expensive and heavy transformer (that may otherwise be present at the output terminals of the inverter) may be eliminated.

In the various embodiments described above, the capacitance of the fuel cell stack 50 is used as a main component for the input capacitance of an inverter. However, in other embodiments of the invention, the capacitance of the fuel cell stack 50 may be used as energy storage for a converter of the fuel cell system.

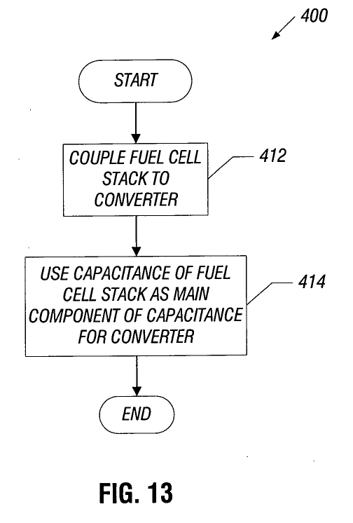

For example, referring to FIG. 13, an embodiment 400 of a technique in accordance with the invention includes coupling (block 412) a fuel cell stack to a converter and using (block 414) the capacitance of the fuel cell stack as a main component of a capacitance for the converter. This capacitance of the converter may be an input capacitance or an output capacitance of the converter.

As a more specific example, in some embodiments of the invention, the above-described inverter may be bi-directional, in that when power is transferred from the fuel cell stack to the power grid, the inverter acts as a conventional inverter. However, in another mode of operation, power flows in the reverse direction through the inverter from the grid to the fuel cell stack. Thus, when in this mode, the inverter behaves as a converter. For this reverse mode, the input capacitance of the inverter becomes the bulk output capacitance of the converter; and the output voltage of the converter (i.e., the inverter operating in a reverse power flow direction) has a ripple voltage component that is limited by the bulk capacitance. In this case, the capacitance of the fuel cell stack provides the needed capacitance to reduce the ripple voltage component of the DC voltage being provided by the converter.

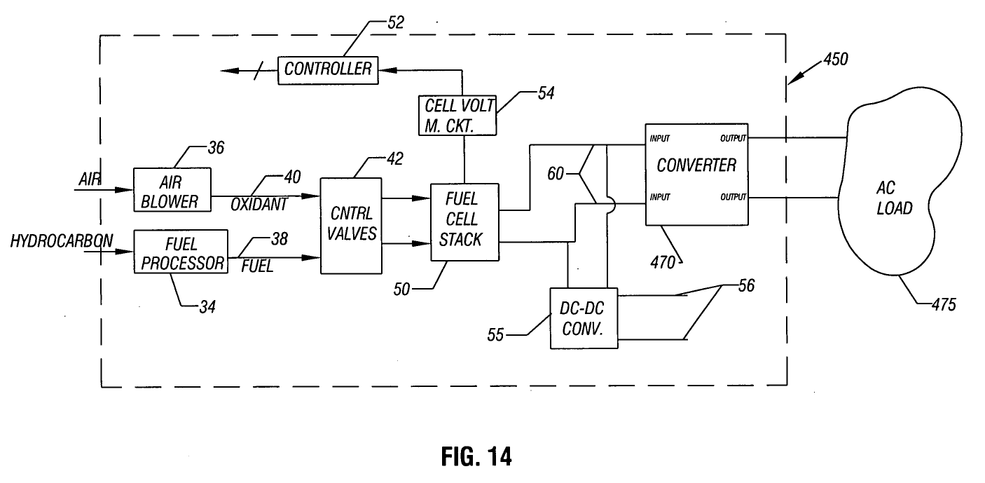

In some embodiments of the invention, the fuel cell stack may not provide power to an AC load, but rather, the fuel cell system may provide power to a DC load. For example, FIG. 14 depicts a fuel cell system 450 in which a fuel cell stack 50 provides power for a DC load 475 (instead of an AC load). The fuel cell system 450 has a similar design to the fuel cell system 30 (FIG. 5), except that the inverter 70 of the system is replaced by a converter 470. For this embodiment of the invention, the capacitance of the fuel cell stack 50 serves as the main component of the input capacitance of the converter 470 that is coupled between the fuel cell stack 50 and the DC load 475. The input capacitance that is provided by the fuel cell stack 50 eliminates an otherwise needed capacitor at the input terminals of the converter and may be useful for systems that have non-AC loads (such as the system 450) but high transient requirements.

This technique is applicable to both single-phase and poly-phase inverters. Polyphase inverters (typically thee phase) have a need for energy storage to supply transient loads and to supply ripple current when the inverter's load is unbalanced.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell stack, comprising:
using a capacitance of the fuel cell stack as a main component of the energy storage of an inverter.

2. The method of claim 1, wherein the using comprises:
coupling the fuel cell stack directly to input terminals of the inverter.

3. The method of claim 1, wherein the using comprises:
coupling a converter between the fuel cell stack and the inverter.

4. The method of claim 1, wherein the main component comprises at least approximately 90 percent of a total capacitance present at input terminals of the inverter.

5. The method of claim 1, further comprising:
coupling at least one additional capacitor to an input terminal of the inverter to filter a voltage associated with a switching frequency of the inverter.

6. A method usable with a fuel cell stack, comprising:
using a capacitance of the fuel cell stack as a main component of the energy storage of a converter.

7. The method of claim 6, wherein the capacitance comprises an input capacitance of the converter.

8. The method of claim 6, wherein the capacitance comprises an output capacitance of the converter.

9. The method of claim 6, further comprising:
operating an inverter in a mode of operation in which power flows from an AC source back to the fuel cell stack.

10. The method of claim 6, further comprising:
using the fuel cell stack to power a DC load.

11. A system comprising:
an inverter; and
a fuel cell stack coupled to the inverter to provide a main component of the input capacitance of the inverter.

12. The system of claim 11, wherein the fuel cell stack is directly connected to input terminals of the inverter.

13. The system of claim 11, further comprising:
a converter coupled between the fuel cell stack and the inverter.

14. The system of claim 11, wherein the main component comprises at least approximately 90 percent of a total capacitance present at input terminals of the inverter.

15. The system of claim 11, further comprising:
at least one capacitor coupled to an input terminal of the inverter to filter a frequency component associated with a switching frequency of the inverter.

16. A system comprising:
an inverter; and
a fuel cell stack coupled to the converter to provide a main component of the capacitance of the converter.

17. The system of claim 16, wherein the capacitance comprises an input capacitance of the converter.

18. The system of claim 16, wherein the capacitance comprises an output capacitance of the converter.

19. The system of claim 16, wherein the converter comprises an inverter adapted to flow power from an AC source back to the fuel cell stack.

20. The system of claim 16, wherein the fuel cell stack is directly connected to at least one input terminal of the inverter.

21. The system of claim 16, further comprising:
an external DC load coupled to the system to be powered with power from the fuel cell stack.
